(19) United States
(12) Patent Application Publication
(10) Pub. No.: US 2009/0149584 A1
(43) Pub. Date: Jun. 11, 2009

(54) USE OF HEXAHYDROPHTHALIMIDE COMBINATIONS AS SOFTENER

(76) Inventors: Klemens Massonne, Bad Durkheim (DE); Boris Breitscheidel, Limburgerhof (DE); Jurgen Holzmann, Schifferstadt (DE); Axel Salden, Stuttgart (DE); Klaus Rossato, Schifferstadt (DE); Martina Egen, Dossenheim (DE); Detlef Kratz, Singapore (SG); Lucien Thil, Limburgerhof (DE); Jan-Dirk Arndt, Mannheim (DE)

Correspondence Address: CONNOLLY BOVE LODGE & HUTZ, LLP, P O BOX 2207, WILMINGTON, DE, 19899, US

(21) Appl. No.: 12/297,839

(22) PCT Filed: Apr. 20, 2007
(86) PCT No.: PCT/EP07/53916

§ 371 Date: Oct. 20, 2008

(30) Foreign Application Priority Data
Apr. 21, 2006 (EP) 06008297.1

(51) Int. Cl. C08K 5/3417

(52) U.S. Cl. 524/104

(57) ABSTRACT

The use of hexahydrophthalimide compounds of the formula (I) is described as plasticizers for molding compositions, in particular polyvinyl chloride,

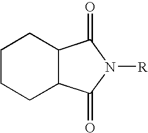

in which
R is alkyl, cycloalkyl, or cycloalkylalkyl, where the two last named moieties can be unsubstituted or alkyl-substituted, and the moiety R has at least 6 carbon atoms.

The invention relates to the use of certain hexahydrophthalimide compounds a 3 plasticizers for thermoplastic polymers, in particular for polyvinyl chloride, and to a molding composition which comprises at least one particular hexahydrophthalimide compound.

Polyvinyl chloride (PVC) is among the most widely used thermoplastic polymers. It has low flammability, and is resistant to chemicals, and corrosion-resistant. The properties of PVC can be varied widely with the aid of plasticizers. As a function of plasticizer content, a distinction is made between rigid PVC (less than 3% of plasticizer) and flexible PVC (more than 3% of plasticizer). Plasticizers used are mainly phthalic, esters, in particular di-n-butyl phthalate (DBP), diisobutyl phthalate (DIBP), di-2-ethylhexyl phthalate (DEHP), diisononyl phthalate (DINP), diisodecyl phthalate (DIDP), and benzyl butyl phthalate (BBP). Materials of less significance are esters of adipic acid and of other organic acids, and also esters of phosphoric acid.

Although phthalates have low acute toxicity, chronic exposure to even small amounts of DEHP can have adverse effects on the testicles, kidneys, and liver. In animal testing, DEHP impaired reproductive capability and led to problems in genital functioning in male progeny. A new risk assessment is currently being undertaken within the scope of the European program relating to existing chemical substances. Certain phthalates have been banned in toys since 1999. These include not only DEHP but also the phthalates DINP, DBP, DIDP, and BBP.

A particularly important factor for the use of plasticizers is their gelling performance for PVC. Gelling performance is the capability of a plasticizer to penetrate into the polymeric structure of the PVC and to bring about a plasticizing effect by reducing the level of interaction between the polymer chains. A measure of the gelling performance of a plasticizer is the solution temperature for PVC, determined to DIN 53408. The lower the solution temperature, the better the gelling performance. Better gelling performance or lower solution temperature of the plasticizer means that lower processing temperatures can be selected in the production of flexible PVC. Lower temperatures save energy and time.

JP 63 301864, U.S. Pat. No. 3,652,312, U.S. Pat. No. 3,615,793, U.S. Pat. No. 3,579,363, U.S. Pat. No. 2,547,542, U.S. Pat. No. 2,684,917, DE 860864, U.S. Pat. No. 3,579,364, U.S. Pat. No. 3,957,862, U.S. Pat. No. 2,547,495 disclose the use of N-substituted phthalimides as plasticizers for various plastics.

U.S. Pat. No. 3,210,313 describes ε-dicarboximidocaproic esters, such as ε-phthalimidocaproic esters, ε-tetrahydrophthalimidocaproic esters, and ε-hexahydrophthalimidocaproic esters, as plasticizers for PVC.

Phthalimides have high solution temperatures for PVC. Tetrahydrophthalimides have olefinic double bonds and are therefore susceptible to oxidation and have a tendency toward yellowing.

It is an object of the invention to provide alternate plasticizers and plasticized molding compositions. The invention is particularly directed at plasticizers which are easy to produce and have good gelling performance and a low solution temperature for PVC.

According to the invention, the object is achieved via a molding composition, comprising a thermoplastic polymer and at least one hexahydrophthalimide compound of the formula (I)

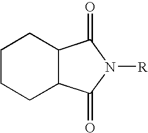

in which
R is alkyl, cycloalkyl, or cycloalkylalkyl, where the two last named moieties can be unsubstituted or alkyl-substituted,
and the moiety R has at least 6 carbon atoms.

The invention further relates to the use of a hexahydrophthalimide compound of the formula (I) as plasticizer for polyvinyl chloride.

For the purposes of the present application, the expression “alkyl” comprises saturated, linear, or branched hydrocarbons. These generally have from 1 to 40 carbon atoms (C₁-C₄₀-alkyl). The alkyl groups are preferably straight-chain or branched alkyl groups. Examples comprise C₁-C₆-alkyl, e.g. methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, and the like. Examples of C₁-C₁-C₄₀-alkyl are C₁-C₆-alkyl, such as those mentioned above, and also heptyl, 1-methylhexyl, 2-methylhexyl, 3-methylhexyl, 4-methylhexyl, 5-methylhexyl, 1-ethylpentyl, 2-ethylpentyl, 3-ethylpentyl, 1-propylbutyl, 1,1-dimethylpentyl, 1,2-dimethylpentyl, 1,3-dimethylpentyl, 1,4-dimethylpentyl, 1-methyl-2-ethylbutyl, 1-ethyl-2-methylbutyl, 1-ethyl-1-methylbutyl, octyl, 1-methylheptyl, 2-methylheptyl, 3-methylheptyl, 4-methylheptyl, 5-methylheptyl, 6-methylheptyl, 1-ethylhexyl, 2-ethylhexyl, 3-ethylhexyl, 4-ethylhexyl, 1-propylpentyl, 2-propylpentyl, 1,1-dimethylhexyl, 1,2-dimethylhexyl, 1,3-dimethylhexyl, 1,4-dimethylhexyl, 1,5-dimethylhexyl, 2,3-dimethylhexyl, 2,4-dimethylhexyl, 2,5-dimethylhexyl, 1-methyl-2-ethylpentyl, 1-methyl-3-ethylpentyl, 1-ethyl-1-methylpentyl, 1-ethyl-2-methylpentyl, 1-ethyl-3-methylpentyl, 1-ethyl-4-methylpentyl, 1-ethyl-2-methylpentyl, 1-ethyl-2,3-dimethylbutyl, nonyl, 1-methyloctyl, 2-methyloctyl, 3-methyloctyl, 4-methyloctyl, 5-methyloctyl, 6-methyloctyl, 7-methyloctyl, 1-ethylheptyl, 2-ethylheptyl, 3-ethylheptyl, 4-ethylheptyl, 5-ethylheptyl, 1,1-dimethylheptyl, 1,2-dimethylheptyl, 1,3-dimethylheptyl, 1,4-dimethylheptyl, 1,5-dimethylheptyl, 1,6-dimethylheptyl, 2,3-dimethylheptyl, 2,4-dimethylheptyl, 2,5-dimethylheptyl, 2,6-dimethylheptyl, 1-propylhexyl, 2-propylhexyl, 3-propylhexyl, 1-methyl-2-ethylhexyl, 1-methyl-3-ethylhexyl, 1-methyl-4-ethylhexyl, 1-ethyl-1-methylhexyl, 1-ethyl-2-methylhexyl, 1-ethyl-3-methylhexyl, 1-ethyl-4-methylhexyl, 1-ethyl-5-methylhexyl, 2-ethyl-2-methylhexyl, 2-ethyl-3-methylhexyl, 2-ethyl-4-methylhexyl, 2-ethyl-5-methylhexyl, decyl, 1-methylnonyl, 2-methylnonyl, 3-methylnonyl, 4-methylnonyl, 5-methylnonyl, 6-methylnonyl, 7-methylnonyl, 8-methylnonyl, 1-ethyloctyl, 2-ethyloctyl, 3-ethyloctyl, 4-ethyloctyl, 5-ethyloctyl, 6-ethyloctyl, 1,1-dimethyloctyl, 1,2-dimethyloctyl, 1,3-dimethyloctyl, 1,4-dimethyloctyl, 1,5-dimethyloctyl, 1,6-dimethyloctyl, 1,7-dimethyloctyl, 2,3-dimethyloctyl, 2,4-dimethyloctyl, 2,5-dimethyloctyl, 2,6-dimethyloctyl, 2,7-dimethyloctyl, 1-propylheptyl, 2-propylheptyl, 3-propylheptyl, 4-propylheptyl, 1-methyl-2-ethylheptyl, 1-methyl-3-ethylheptyl, 1-methyl-4-ethylheptyl, 1-methyl-5-ethylheptyl, 1-ethyl-1-methylheptyl, 1-ethyl-2-methylheptyl, 1-ethyl-3-methylheptyl, 1-ethyl-4-methylheptyl, 1-ethyl-5-methylheptyl, 1-ethyl-6-methylheptyl, 2-ethyl-2-methylheptyl, 2-ethyl-3-methylheptyl, 2-ethyl-4-methylheptyl, 2-ethyl-5-methylheptyl, 2-ethyl-6-methylheptyl, undecyl, 1-methyldecyl, 2-methyldecyl, 9-methyldecyl, 1-ethylnonyl, 2-ethylnonyl, 1,1-dimethylnonyl, 1,2-dimethylnonyl, 1,3-dimethylnonyl, 1,4-dimethylnonyl, 1,5-dimethylnonyl, 1,6-dimethylnonyl, 1,7-dimethylnonyl, 1,8-dimethylnonyl, 2,3-dimethylnonyl, 2,4-dimethylnonyl, 2,5-dimethylnonyl, 2,6-dimethylnonyl, 2,7-dimethylnonyl, 2,8-dimethylnonyl, 1-propyloctyl, 2-propyloctyl, 1-methyl-2-ethyloctyl, 1-methyl-3-ethyloctyl, 1-methyl-4-ethyloctyl, 1-methyl-5-ethyloctyl, 1-methyl-6-ethyloctyl, 1-ethyl-1-methyloctyl, 1-ethyl-2-methyloctyl, 1-ethyl-3-methyloctyl, 1-ethyl-4-methyloctyl, 1-ethyl-5-methyloctyl, 1-ethyl-6-methyloctyl, 2-ethyl-2-methyloctyl, 2-ethyl-3-methyloctyl, 2-ethyl-4-methyloctyl, 2-ethyl-5-methyloctyl, 2-ethyl-6-methyloctyl, dodecyl, 1-methylundecyl, 2-methylundecyl, 10-methylundecyl, 1-ethyldecyl, 2-ethyldecyl, 1-propylnonyl, 2-propylnonyl, tridecyl, 1-methyldodecyl, 2-methyldodecyl, 11-methyldodecyl, 1-ethylundecyl, 2-ethylundecyl, 1-propyldecyl, 2-propyldecyl, 1,2,6-trimethyldecyl, 1,2,7-trimethyldecyl, 1,2,8-trimethyldecyl, 1,5,9-trimethyldecyl, 2,4,6-trimethyldecyl, 2,7,8-trimethyldecyl, tetradecyl, 1-methyltridecyl, 2-methyltridecyl, 12-methyltridecyl, 1-ethyldodecyl, 2-ethyldodecyl, 1-propylundecyl, 2-propylundecyl, pentadecyl, 1-methyltetradecyl, 2-methyltetradecyl, 13-methyltetradecyl, 1-ethyltridecyl, 2-ethyltridecyl, 1-propyldodecyl, 2-propyldodecyl, hexadecyl, 1-methylpentadecyl, 2-methylpentadecyl, 14-methylpentadecyl, 1-ethyltetradecyl, 2-ethyltetradecyl, 1-propyltridecyl, 2-propyltridecyl, heptadecyl, 1-methylhexadecyl, 2-methylhexadecyl, 15-methylhexadecyl, 1-ethylpentadecyl, 2-ethylpentadecyl, 1-propyltetradecyl, 2-propyltetradecyl, octadecyl, 1-methylheptadecyl, 2-methyheptadecyl, 16-methylheptadecyl, 1-ethylhexadecyl, 2-ethylhexadecyl, 1 propylpentadecyl, 2-propylpentadecyl, nonadecyldecyl, 1-methyloctadecyl, 2-methyoctadecyl, 17-methyloctadecyl, 1-ethylheptadecyl, 2-ethylheptadecyl, 1-propylhexadecyl, 2-propylhexadecyl, icosanyl, 1-methylnonadecyl, 2-methylnonadecyl, 18-methylnonadecyl, 1-ethyloctadecyl, 2-ethyloctadecyl, 1-propylheptadecyl, 2-propylheptadecyl, henicosanyl, 1-methylicosanyl, 2-methylicosanyl, 19-methylicosanyl, 1-ethylnonadecyl, 2-ethylnonadecyl, 1-propyloctadecyl, 2-propyloctadecyl, docosanyl, triacontanyl, tetracontanyl, and the like.

The expression “cycloalkyl” comprises monocyclic, saturated hydrocarbon groups generally comprising from 3 to 14 carbon atoms as ring members, examples being cyclopropyl, cyclobutyl, cyclopentyl, cyclohexyl, cycloheptyl, cyclooctyl, cyclononyl, cyclodecyl, cycloundecyl, cyclododecyl, cyclotridecyl, and cyclotetradecyl. In principle, cycloalkyl can have one or more, e.g. one, two, three, four, five, or six, alkyl substituents, an example being C₁-C₆-alkyl. Examples comprise 2-, 3-methylcyclopentyl, 2,2-dimethylcyclopentyl, 2,5-dimethylcyclopentyl, 4-methylcyclohexyl, 4,4-dimethylcyclohexyl, 2-, 3-, 4-methylheptyl, 2-, 3-, 4-methyloctyl, and the like.

The expression “cycloalkylalkyl” designates an alkyl as defined above substituted by one or more monocyclic, saturated hydrocarbon groups generally having from 3 to 14 carbon atoms as ring members, examples being cyclopropyl, cyclobutyl, cyclopentyl, cyclohexyl, cycloheptyl, cyclooctyl, cyclononyl, cyclodecyl, cycloundecyl, cyclododecyl, cyclotridecyl, and cyclotetradecyl. In principle, the cycloalkyl fraction can have one or more, e.g. one, two, three, four, five, or six, alkyl substituents, an example being C₁-C₆-alkyl. Examples of cycloalkylalkyl comprise cyclohexylmethyl, 2-(cyclohexyl)ethyl, and the like.

In one preferred embodiment, R is branched alkyl having from 6 to 28 carbon atoms, in particular branched C₇-C₁₅-alkyl. The alkyl moiety can have one or more branches, in particular one or two branches, particularly preferably one branch. The branches are preferably methyl branches, ethyl branches, or n-propyl branches. Particular preference is given to compounds I in which R is C₇-C₁₅-alkyl with a branch at the β carbon atom, examples being 2-ethylpentyl, 2-ethylhexyl, 2-propylpentyl, 2-ethylheptyl, 2-propylhexyl, 2-ethyloctyl, 2-propylheptyl, 2-ethylnonyl, or 2-propyloctyl.

In another preferred embodiment, R is isoalkyl having from 8 to 28 carbon atoms, in particular from 9 to 20 or from 10 to 18 carbon atoms, for example 8, 9, 10, or 3 carbon atoms, and having an average degree of branching of from 1.1 to 3.0, in particular from 1.5 to 2.5. Among these are isooctyl, isononyl, isodecyl, isoundecyl, isododecyl, and isotridecyl. These are generally mixtures of branched alkyl moieties having an identical or different number of carbon atoms. The isoalkyl moieties mostly derive from primary alcohols obtained via oligomerization of C₂-C₆ olefins and subsequent hydroformylation and hydrogenation.

The vapor pressure of hexahydrophthalimide compounds whose use is preferred is less than 30 hPa at 200° C., in particular less than 25 hPa.

The compounds of the formula I can be prepared in many ways by methods from the literature, in which connection see Beilstein, Springer Verlag 1989, 5th. Suppl. Series EV 21/10 pages 78 et seq.

By way of example, the compounds of the formula I can be prepared by reaction of cyclohexanedicarboxylic acid or cyclohexanedicarboxylic anhydride with a primary amine R—NH₂. The solvent used for these reactions is—as a function of temperature range—aliphatic, cycloaliphatic, or aromatic hydrocarbons, such as hexane, cyclohexane, toluene, xylene, mesitylene, or a mixture of these solvents. The water of reaction is advantageously removed, for example by a separator.

Cyclohexanedicarboxylic acid (anhydride) can be obtained by the process described in WO 02/066412.

Thermoplastic polymers with which the plasticizers used according to the invention can be admixed are not only PVC but also polyvinyl acetals, such as polyvinyl butyral, polyacrylates, cellulose esters, in particular nitrocellulose, and cellulose acetate, and polysulfides.

The content of compounds of the formula (I)—stated in phr—in molding compositions of the invention can generally be from 5 to 100 phr, preferably from 10 to 60 phr, and particularly preferably from 20 to 50 phr. The conventional “phr” mixing specification data for polymer compositions is the abbreviation for “parts per hundred resin”, and means that the amounts weighed, measured, and stated of additives are not based on their percentage in the entire composition but instead are parts by weight per 100 parts by weight of polymer. If, for example, the compound of the formula (I) is present in the PVC/plasticizer mixture in a PVC:plasticizer ratio by weight of 80:20, the content of ester mixture is 25 phr, since 20 parts represent 25% of 80 parts.

Polyvinyl chloride is obtained by homopolymerization of vinyl chloride. The polyvinyl chloride (PVC) used according to the invention can by way of example be prepared by suspension polymerization, microsuspension polymerization, emulsion polymerization, or bulk polymerization. The preparation of PVC by polymerization of vinyl chloride, and also the production and constitution of plasticized PVC, are described by way of example in “Becker/Braun, Kunststoff-Handbuch [Plastics handbook], volume 2/1: Polyvinylchlorid [Polyvinyl chloride]”, 2^{nd} edition, Carl Hanser Verlag, Munich.

The K value, which characterizes the molar mass of the PVC and is determined to DIN 53726, is mostly from 57 to 90 for the PVC plasticized according to the intention, preferably from 61 to 85, in particular from 64 to 75.

The molding composition of the invention may comprise not only the imidazole compound but also other suitable additives.

By way of example, it can comprise light stabilizers, biostabilizers, or other stabilizers, lubricants, fillers, pigments, flame retardants, blowing agents, polymeric processing aids, impact modifiers, optical brighteners, or antistatic agents.

Purely for illustrative purposes, some of these additives and their function are described by way of example below, but these descriptions have no limiting effect in relation to the molding composition of the invention.

Stabilizers neutralize, by way of example, the hydrochloric acid eliminated from PVC during and/or after processing, or act as free-radical scavengers to counter PVC degradation.

Stabilizers that can be used are any of the conventional stabilizers in solid and liquid form, for example conventional Ca/Zn stabilizers, conventional Ba/Zn stabilizers, conventional Pb stabilizers, or conventional Sn stabilizers, or else acid-binding phyllosilicates, such as hydrotalcite. Preference is given to Ba/Zn stabilizers, tribasic lead sulfate (3 PbO*PbSO₄*H₂O), and lead phosphite, particular preference being given to tribasic lead sulfate and lead phosphite. Dibutyltin maleate may be mentioned as an example of a free-radical scavenger.

The content of stabilizers in the molding compositions of the invention can be from 0.05 to 7 phr, preferably from 0.1 to 5 phr, and particularly preferably from 0.2 to 4 phr.

Lubricants are intended to act between PVC particles and the hot parts of the machinery during processing, and to counter frictional forces during mixing, plastification, and deformation.

Lubricants that can be present in the molding compositions of the invention are any of the conventional lubricants for the processing of PVC. By way of example, those that can be used are hydrocarbons, such as oils, paraffins, and polyethylene waxes, fatty acid salts, fatty alcohols having from 10 to 20 carbon atoms, ketones, carboxylic acids, such as fatty acids and montanic acid, oxidized polyethylene wax, metal salts of carboxylic acids, carboxamides, and carboxylic esters, for example with the following alcohols: ethanol, fatty alcohols, glycerol, ethanediol, pentaerythritol, and with long-chain carboxylic acids as acid component.

The content of lubricants in the molding compositions of the invention can be from 0.01 to 10 phr, preferably from 0.05 to 5 phr, and particularly preferably from 0.1 to 3 phr.

Fillers primarily affect compressive strength, tensile strength, and flexural strength, and the hardness and heat resistance of flexibilized polyvinyl chloride, this effect being favorable.

The molding compositions of the invention can receive admixtures of fillers, for example inorganic fillers, such as naturally occurring calcium carbonates, e.g. chalk, limestone, and marble, synthetic calcium carbonates, dolomite, silicates, silica, sand, diatomaceous earth, aluminum silicates, such as kaolin, mica, and feldspar. Fillers used with preference are calcium carbonates, chalk, dolomite, kaolin, silicates or talc, and chalk or calcite is used with particular preference.

The content of fillers in the compositions to be used according to the invention can be from 0.01 to 100 phr, and preferably from 1 to 80 phr.

The molding compositions of the invention can also comprise pigments, in order to adapt the resultant product to various possible uses.

Use may be made here of either inorganic pigments or organic pigments. Examples of inorganic pigments that can be used are titanium pigments, such as TiO₂, cobalt pigments, such as CoO/Al₂O₃, and chromium(III) pigments, such as Cr₂O₃. Examples of organic pigments that can be used are condensed azo pigments, azomethine pigments, anthraquinone pigments, quinacridones, phthalocyanine pigments, dioxazine pigments, such as C.I. Pigment Violet 23, and aniline black (C.I. Pigment Black 1).

The content of pigments in the molding compositions of the invention can be from 0.01 to 10 phr, preferably from 0.05 to 5 phr, particularly preferably from 0.1 to 3 phr, and in particular from 0.5 to 2 phr.

The molding compositions of the invention can also receive admixtures of flame retardants, in order to reduce flammability and to lessen smoke generation on combustion.

Examples of flame retardants that can be used are antimony trioxide, phosphoric esters, chloroparaffin, aluminum hydroxide, boron compounds, molybdenum trioxide, or ferrocene. It is preferable to use antimony trioxide or phosphoric esters, particularly preferably phosphoric esters, in particular bisphenyl cresyl phosphate, diphenyl octyl phosphate, or tricresyl phosphate.

The content of flame retardants in the molding compositions of the invention can be from 0.01 to 100 phr, and preferably from 0.1 to 20 phr.

Light stabilizers can also be added to these dry PVC mixtures, in order to protect items produced from the molding compositions of the invention from surface damage via exposure to light.

Examples of compounds that can be used here are hydroxybenzophenones, hydroxyphenylbenzotriazoles, or cyanophenylacrylates. Cyanophenylacrylates are preferred, and 2-ethylhexyl 2-cyano-3,3-diphenylacrylate is particularly preferred.

The amount of light stabilizers that can be present in the molding compositions of the invention is from 0.01 to 7 phr, preferably from 0.1 to 5 phr, and particularly preferably from 0.2 to 1 phr.

The usual method of producing plasticized PVC with use of the plasticizers of the invention is to mix the individual components with stirring at elevated temperatures. A general description of the preparation of mixtures of polyvinyl chlorides, plasticizers, and further additives is given by way of example in “Becker/Braun, Kunststoff-Handbuch [Plastics handbook], volume 2/1: Polyvinylchlorid [Polyvinyl chloride]”, 2^{nd} edition, Carl Hanser Verlag, Munich.

In one preferred production process, the polyvinyl chloride and all of the other solid constituents are first mixed by stirring using a stirrer speed of from 500 to 5000 rpm (revolutions per minute), preferably from 1000 to 3000 rpm, particularly preferably from 2000 to 2500 rpm, at a temperature of from 30 to 150° C., preferably from 40 to 100° C., particularly preferably from 50 to 70° C. The plasticizers of the invention and all of the other liquid constituents are then added and mixed by stirring at a stirrer speed of from 500 to 5000 rpm (revolutions per minute), preferably from 1000 to 3000 rpm, particularly preferably from 2000 to 2500 rpm, the temperature being increased to a final value here of from 70 to 190° C., preferably from 80 to 160° C., particularly preferably from 90 to 130° C. The mixture is then cooled to room temperature and can be further processed to give finished items.

The plasticizers of the invention are suitable by way of example for the production of PVC foils. The plasticizers of the invention are particularly suitable for the production of self-adhesive films, of motor vehicle foils, of furniture foils and of office-requisite foils, of agricultural foils, of foils for food or drink (cling film), of roof sheeting, of oil-tank-interior foils, of water-reservoir foils, of swimming-pool foils, of buildings-protection foils, of raincoats, of swing doors, of shower curtains, of inflatable boats, and of water wings.

The plasticizers of the invention are moreover suitable for the production of PVC cables. The plasticizers of the invention are particularly suitable for the production of wiring cables, power cables, communications cables, coiled cords, computer cables, and automobile cables.

The plasticizers of the invention are also suitable for the production of PVC coatings. The plasticizers of the invention are particularly suitable for the production of synthetic leather (for use in automobile construction or in bagmaking), of truck tarpaulins and tenting, of tablecloths, of protective apparel, of vinyl wallpapers, and of conveyor belts.

The plasticizers of the invention are moreover suitable for the production of PVC floorcoverings. The plasticizers of the invention are particularly suitable for the production of foamed floorcoverings (cushion vinyl), of heterogeneous compact coverings, of homogeneous compact coverings, and of coatings for wall-to-wall carpets.

The plasticizers of the invention are also suitable for the production of PVC profiles. The plasticizers of the invention are particularly suitable for the production of industrial hoses and of garden hoses, of gaskets (for use by way of example in refrigerators), of medical tubing, and of stair handrails.

The plasticizers of the invention are also particularly suitable for the production of shoes, inclusive of boots and sandals, of toys, inclusive of dolls and footballs, (if gloves, inclusive of industrial and medical gloves, of underbody protection, of cap closures, of bellows, and of rubber erasers.

These finished items can be produced by means of calendaring, extrusion, coating, casting, dip coating, rotor molding, or injection molding. Further details of these processes are found by way of example in “Becker/Braun, Kunststoff-Handbuch [Plastics handbook], volume 2/1: Polyvinylchlorid [Polyvinyl chloride]”, 2nd edition, Carl Hanser Verlag, Munich.

The examples below provide further illustration of the invention.

### EXAMPLE 1

### Synthesis of N-2-ethylhexylhexahydrophthalimide

154.0 g (1.0 mol) of cyclohexane-1,2-dicarboxylic anhydride in 500 ml of mesitylene were used as initial charge in a 1 l stirred flask with internal thermometer and water separator. The mixture was heated at reflux and 130.0 g (1.0 mol) of 2-ethylhexylamine were added dropwise within a period of 90 min. After 8 hours, the water separator had removed 15 ml of water.

After cooling to room temperature, the solution was extracted by shaking five times with 200 ml of 2% strength sodium hydroxide solution and then washed twice with 200 ml of water, and dried over potassium carbonate. The solvent was removed by distillation on a rotary evaporator using a bath temperature of 60° C. and vacuum provided by an oil pump.

This gave 257.7 g of a yellowish liquid; purity (GC): 97%; acid number: 1.9 mg KOH/g. Yield: 94% of theory.

398.16 g of crude product (from two batches) were distilled in vacuo. This gave the following fractions:

| | | | | Acid | GC [% by area] | | |
|---|---|---|---|---|---|---|---|
| | Amount | Pressure | Overhead | number | Title | Ethylhexyl- | |
| Fraction | [g] | [mbar] | temp. [° C.] | [mg KOH/g] | comp. | amine | Mesitylene |
| Amount | 398.16 | | | 1.9 | 97 | | |
| used | | | | | | | |
| 1 | 12.23 | 3.6 | 30 | | | <1 | >99 |
| 2 | 8.58 | 0.06 | 111-115 | 2.95 | 94 | | 1 |
| 3 | 57.14 | 0.06 | 124 | 2.02 | 99 | | 1 |
| 4 | 279.72 | 0.05 | 122-127 | <0.1 | 100 | | |
| 5 | 23.62 | 0.04 | 127 | 1.92 | >99 | | |
| Residue | 13.69 | | | | | | |

Fractions 3, 4, and 5 were combined and used for the following tests.

### EXAMPLE 2

### Solution Temperatures

In accordance with DIN 53408, the solution temperatures of N-2-ethylhexylhexahydrophthalimide were measured for PVC. For comparison, the solution temperatures of the known plasticizers di(2-ethylhexyl) phthalate and diisobutyl phthalate were determined. Vapor pressure measurements were carried out in accordance with annex A4 to European Commission specification 92/69/ECC, OECD test specification 104 and, respectively, EPA test specification OPPTS 830.7950. The following table compares the results.

| | N-2-Ethylhexyl- | | |
|---|---|---|---|
| | hexahydro- | Diisobutyl | Di(2-ethylhexyl) |
| | phthalimide | phthalate | phthalate |
| Solution temperature | 99 | 99 | 124 |
| for PVC [° C.] | | | |
| Vapor pressure [hPa] | | | |
| 140° C. | 1.07 | 1.50 | 0.04 |
| 160° C. | 3.00 | 4.20 | 0.17 |
| 180° C. | 7.51 | 10.70 | 0.58 |
| 200° C. | 17.09 | 24.40 | 1.80 |
| Boiling point | | 295° C. | 384° C. |

The results show that the solution temperature for PVC of the plasticizer of the invention from Example 1 is comparably low with that of the typical fast-gelling plasticizer diisobutyl phthalate, this being markedly below that of the standard plasticizer di(2-ethylhexyl) phthalate. The vapor pressure of the plasticizer of the invention is significantly lower than that of diisobutyl phthalate over the entire relevant temperature range from 140 to 200° C.

1. A molding composition, comprising a thermoplastic polymer and at least one hexahydrophthalimide compound of the formula (I) 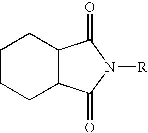
in which
R is alkyl, cycloalkyl, or cycloalkylalkyl, where the two last named moieties can be unsubstituted or alkyl-substituted,
and the moiety R has at least 6 carbon atoms.

2. The molding composition according to claim 1, in which R is branched alkyl having from 6 to 28 carbon atoms.

3. The molding composition according to claim 1, in which R is isoalkyl having from 8 to 28 carbon atoms, and having an average degree of branching of from 1.1 to 3.0.

4. The molding composition according to claim 1, where the vapor pressure of the hexahydrophthalimide compound at 200° C. is less than 25 hPa.

5. The molding composition according to claim 1, where the thermoplastic polymer is polyvinyl chloride.

6-8. (canceled)

8. The molding composition according to claim 2, where the vapor pressure of the hexahydrophthalimide compound at 200° C. is less than 25 hPa.

9. The molding composition according to claim 3, where the vapor pressure of the hexahydrophthalimide compound at 200° C. is less than 25 hPa.

10. The molding composition according to claim 4, where the vapor pressure of the hexahydrophthalimide compound at 200° C. is less than 25 hPa.

11. The molding composition according to claim 2, where the thermoplastic polymer is polyvinyl chloride.

12. The molding composition according to claim 3, where the thermoplastic polymer is polyvinyl chloride.

13. The molding composition according to claim 4, where the thermoplastic polymer is polyvinyl chloride.

14. The molding composition according to claim 5, where the thermoplastic polymer is polyvinyl chloride.
